(19) United States
(12) Patent Application Publication
(10) Pub. No.: US 2022/0127424 A1
(43) Pub. Date: Apr. 28, 2022

(54) EASILY SOLUBLE AND FREE-FLOWING GRANULAR MATERIAL ON THE BASIS OF HIGH-TEMPERATURE THERMOPLASTICS WITH A LOW CONTENT OF VOLATILE ORGANIC COMPOUNDS

(71) Applicant: BASF SE, Ludwigshafen am Rhein (DE)

(72) Inventors: Simon GRAMLICH, Ludwigshafen am Rhein (DE); Juergen AHLERS, Ludwigshafen am Rhein (DE); Peter GUTMANN, Ludwigshafen am Rhein (DE); Isa Alexandra QUEIROZ DA FONSECA, Ludwigshafen am Rhein (DE)

(21) Appl. No.: 17/428,526

(22) PCT Filed: Jan. 31, 2020
(86) PCT No.: PCT/EP2020/052422

§ 371 Date: Aug. 4, 2021

(30) Foreign Application Priority Data
Feb. 4, 2019 (EP) 19155300.7

(51) Int. Cl. C08J 3/12; C08J 9/18; C08L 81/06; B01J 2/20

(52) U.S. Cl. CPC C08J 3/124; C08J 9/18; C08L 81/06; C08L 2205/025; C08J 2381/06; C08J 2203/10; C08J 2481/06; B01J 2/20

(57) ABSTRACT

Granulate based on high-temperature thermoplastics with a bulk density in the range of 100 to 650 kg/m³ in accordance with DIN ISO 697:1984 and less than 1% by weight content of volatile organic compounds, and also method for their production and use for the production of membranes or coatings, or for the toughness-modification of reactive resins.

The present invention relates to readily soluble and flowable granulates based on high-temperature thermoplastics with low content of volatile organic compounds, and also to methods for their production and use.

Production of membranes or coatings generally requires solutions of high-temperature thermoplastics, in particular polyether sulfones. For that purpose it is preferable to use flowable high-temperature thermoplastics which rapidly dissolve in the solvents used. Compact granulates generally dissolve only slowly. Powders or flakes are frequently susceptible to clumping.

WO 94/15999 describes micropowders made of polyarylene ether sulfones or of polyarylene ether ketones, in each case with spherical particles having an in essence smooth surface structure, these being obtainable via spray drying of polyarylene ether sulfone solutions in N-methylpyrrolidone, dimethyl sulfoxide or dimethylformamide. The micropowders feature a narrow particle size distribution with average particle diameters of 2-70 μm, and are in particular suitable for the coating of metallic surfaces. In order to reduce the content of residual solvents, it is generally necessary to carry out an afterdrying procedure, for example in a fluidized bed or moving bed.

US 2012/0245239 A1 describes polyetherimide particles or powders with a large surface area and with high porosity, these being obtainable via precipitation from polymer solutions in hot water or steam. Although the solubility of the polyetherimide powders in N-methylformamide at 80° C. is below that of mechanically comminuted polyetherimides, the time required is still in the region of one hour.

PCT/EP2018/070084, not yet published, describes expandable, blowing-agent-containing granulates based on high-temperature thermoplastics, and also a method for their production. The expandable blowing-agent-containing granulates can be foamed to give foam particles with a bulk density in the range of 10 to 200 kg/m³ in accordance with DIN ISO 697:1984.

Residual contents of solvents such as acetone, methyl ethyl ketone, ethanol, isopropanol, N-methylpyrrolidone, dimethylformamide, sulfolane or dimethyl sulfoxide, these being used in the abovementioned methods for the production of the high-temperature thermoplastics, are generally problematic during further processing to give coatings or membranes, for example dialysis membranes. The solvents therefore require expensive removal from the polymer granulates.

WO 2014/033321 describes a solvent-free method for the production of aromatic polyether sulfones via reaction of a dichlorodiphenyl sulfone component with a bisphenol component in the presence of alkali metal carbonate in the melt in a mixing kneader. That method produces solvent-free granulates, but these can only be redissolved slowly in solvents, for example N-methylpyrrolidone.

It was therefore an object of the present invention to provide readily soluble and flowable granulates with low content of volatile organic compounds, and methods for their production.

The object has been achieved via granulates based on high-temperature thermoplastics with a bulk density in the range of 100 to 650 kg/m³ in accordance with DIN ISO 697:1984 and less than 1% by weight content of volatile organic compounds.

Preferred embodiments can be found in the dependent claims.

The following can be used according to the invention as high-temperature thermoplastics: amorphous thermoplastic polymers with a glass transition temperature T_{g} of at least 165° C., preferably in the range of 180° C. to 240° C., measured by means of differential scanning calorimetry (DSC) in accordance with ISO 11357-2:1999 with a heating rate of 10 K/min, and semicrystalline thermoplastic polymers with a melting peak temperature Tₚₘ in accordance with ISO 11357-3:2011-05-01 of at least 250° C., preferably in the range of 260 to 350° C.

Preferred high-temperature thermoplastics are polyaryl ether sulfones, polyaryl ether ketones, polyphenylene sulfides, polyetherimides, polyphenyleneamides, polycarbonates, aromatic polyester carbonates, high-temperature polyamides (HTPA), thermoplastic polyoxazolidones and copolycarbonates (PC-HAT) derived from BPA and BPTMC. Particular preference is given to polysulfones (PSU), polyphenyl sulfones (PPSU) and polyether sulfones (PESU).

According to the invention, the bulk density of the granulates is in the range of 100 to 650 kg/m³ in accordance with DIN ISO 697:1984, preferably in the range of 210 to 390 kg/m³. In case of bulk densities below 100 kg/m³, the granulates can float during dissolution in the solvent, and in the case of bulk densities above 700 kg the time required for complete dissolution of the granulates increases.

The granulates preferably have less than 0.1% by weight content of volatile organic compounds (VOC), particularly preferably less than 0.01%. The expression “volatile organic compound” means compounds with a boiling point between that of isopentane (28° C.) and that of n-hexadecane (287° C.). The total content of acetone, ethanol, isopropanol, N-methylpyrrolidone, dimethylformamide, sulfolane and dimethyl sulfoxide, based on the granulates, is particularly preferably below 1% by weight, very particularly preferably below 0.1% by weight. The content of volatile organic compounds (VOC) can by way of example be determined by headspace GC/MS or as described in DIN ISO 16000-6:2012-11.

The average mass of the pellets is generally in the range of 1 to 50 mg, preferably in the range of 3 to 20 mg, particularly preferably in the range of 3 to 8.5 mg. The average mass is determined by weighing about 100 pellets and determining the average value for one pellet.

The granulates are generally spherical, ellipsoid or cylindrical. They are preferably spherical or ellipsoid, with an L/D ratio (longest dimension (L) to diameter (D) of the pellets) in the range of 1/1 to 2.5/1, preferably in the range of 1/1 to 2/1. In the case of L/D ratios above 2.5/1 or below 1/2, flowability decreases greatly. The L/D ratio can be determined by measuring at least 20 pellets and calculating an average value, or preferably via dynamic image analysis (Camsizer), in which cameras were used to record the shadow projection of granulates flowing through a chute.

The granulates of the invention can be dissolved rapidly in familiar solvents. It is preferable that 2 g of the granulate dissolve completely in 100 ml of N-methylpyrrolidone at 80° C., in less than 100 minutes, preferably less than 60 minutes.

The granulates of the invention are flowable. Their flowability value is preferably in the range of 1 to 6 seconds, particularly preferably in the range of 2 to 5 seconds, measured in accordance with DIN EN ISO 6186-1998.

The granulates preferably consist of a high-temperature thermoplastic, particularly preferably of a polyaryl ether sulfone with an intrinsic viscosity in the range of 40 to 100 cm³/g, measured in accordance with ISO 307, 1157,1628 in 0.01 g/ml phenol/1,2 ortho-dichlorobenzene, 1:1 is used as high-temperature thermoplastic.

The granulates preferably comprise no solids as additives, in particular no fillers or nucleating agents, for example talc.

The invention also provides methods for the production of the granulates of the invention via extrusion of a blowing-agent-containing melt of the high-temperature thermoplastic.

A preferred method for the production of the granulates described above of the invention comprises the stages of:
a) production of a polymer melt via melting of at least one high-temperature thermoplastic with less than 1% by weight content of volatile organic compounds, preferably less than 0.1% by weight,
b) addition of a blowing agent to the polymer melt
c) optionally conveying of the polymer melt by way of a gear pump
d) conveying of the blowing-agent-containing polymer melt at a temperature in the range of 250° C. to 350° C. through a pelletizing die and
e) granulation of the blowing-agent-loaded polymer melt.

Another preferred method for the production of the granulates described above of the invention comprises the stages of:
a) production of a polymer melt via reaction of a dichlorodiphenyl sulfone component with a bisphenol component as monomers in the presence of alkali metal carbonate in the melt in the absence of solvents or diluents, followed by removal of salts,
b) addition of a blowing agent to the polymer melt
c) optionally conveying of the polymer melt by way of a gear pump and a melt filter,
d) conveying of the blowing-agent-containing polymer melt at a temperature in the range of 250° C. to 350° C. through a pelletizing die and
e) granulation of the blowing-agent-loaded polymer melt.

The granulation in both preferred methods can be achieved by means of extrudate pelletization, water-cooled die-face pelletization or underwater pelletization. The granulation in stage e) of the two preferred methods preferably takes place in an underwater pelletizer operated at a water temperature in the range of 75 to 99° C. and at a pressure in the range of 1 to 10 bar.

Nitrogen, carbon dioxide, water or mixtures thereof are preferably used as blowing agent. Quantities added of the blowing agent or blowing mixtures are 1 to 10% by weight, preferably 2 to 5% by weight, based on the high-temperature thermoplastics.

The bulk density of the granulates of the invention can be controlled via the selection of the blowing agent and of the pressure in the underwater pelletizer. Low bulk densities are achieved via lower pressures and/or smaller quantities of blowing agent.

The polymers described above for the granulates of the invention can be used as high-temperature thermoplastic. It is preferable to use a polyarylene ether sulfone with an intrinsic viscosity in the range of 40 to 100 cm³/g, measured in accordance with ISO 307, 1157,1628 in 0.01 g/ml phenol/1,2 ortho-dichlorobenzene, 1:1 is used as high-temperature thermoplastic.

Suitable polyether sulfones with low residual monomer content can be attained by way of example via reaction of a dichlorodiphenyl sulfone component with a bisphenol component as monomers in the presence of alkali metal carbonate in the melt in the absence of solvents or diluents, followed by removal of the salts, as described in WO 2014/033321 and WO 2017/162485.

It is preferable that no solids are added as additives to the polymer melt, in particular no fillers or nucleating agents, for example talc.

The granulates of the invention can preferably be used for the production of membranes, in particular dialysis membranes, coatings, or for the toughness-modification of reactive resins.

### EXAMPLES

Raw materials used:
Ultrason E2010 natural polyether sulfone granulate from BASF SE, density 1370 kg/m³, intrinsic viscosity 56 cm³/g, DSC glass transition temperature (10° C./min) 225° C., bulk density 750 g/l.
Ultrason E3010 natural polyether sulfone granulate from BASF SE, density 1370 kg/m³, intrinsic viscosity 66 cm³/g, DSC glass transition temperature (10° C./min) 225° C.) bulk density 750 g/l.

Blowing agent: H₂O

Test Methods:

Determination of Bulk Density:

The bulk density of the blowing-agent-free, porous granulates was determined in accordance with DIN ISO 697:1984.

Determination of Solubility

Solubility was determined by in each case dissolving 2 g of polyether sulfone in 100 ml of N-methylpyrrolidone (NMP) in a glass beaker at 80° C. on a vibrator plate at 150 rpm. The time required for complete dissolution of the granulates was measured. The rotation rate of the vibrator plate was 150 rpm for 30 min, and then 300 rpm.

Determination of Flowability

The flowability value of the granulates was determined in accordance with DIN EN ISO 6186:1998, method B, and with a test funnel with outlet diameter of 15 mm.

Determination of Content of Volatile Organic Compounds (VOC)

The content of volatile organic compounds (VOC) was determined by means of headspace GC/MS as follows.

Headspace Measurement Conditions:

Sample temperature: 70° C.

Temperature control period: 60 min

Interface temperature: 150° C.

Standard pressure: 115 kPa

High pressure: 180 kPa

Injection time: 0.20 min

Cryofocusing: 2.5/2.5 min (pre/post)

Starting weight: 152 mg sample+2 ml DMAA

GC/MS measurement conditions

Separation capillary: DB-1 30 m 0.25 mm 1 μm

Temperature program: 40° C.; 8.5 min; 5° C./min; 260° C.; 10 min

Inlet pressure: 70 kPa

Split: ca. 20 ml/min

Scan: 25-400 amu

Acetone and isopropanol were used as reference for the quantitative determination.

Determination of the L/D Ratio:

The L/D ratio was determined by dynamic image analysis (Camsizer), in which cameras were used to record the shadow projection of granulates flowing through a chute. The characteristic variable L/D was determined from the Camsizer dimension b/I₃, b/I₃=xc,min/xFe,max, where xc,min is the shortest chord in the projection plane and xFe,max, is the maximal Feret diameter in the projection plane. L/D=I₃/b.

Examples B-1-B-6: Production of porous granulates from polyether sulfones

Production of the porous granulates took place in an apparatus consisting of a twin-screw extruder from Leistritz divided into eight zones (Z1 . . . Z8) with 18 mm screw diameter and with a length-to-diameter ratio of 40, with a melt pump (gear pump GP), start-up valve (SUV), melt filter, pelletizing die (PD) and an underwater pelletizer (UWP).

Polyether sulfone (PESU) was metered into the twin-screw extruder and melted. Downstream of about ⅔ of the length of the extruder, the blowing agent H₂O was injected into the extruder with the aid of Isco pumps (piston pumps from Axel Semrau) and an injector incorporated into the extruder. The melt pump (GP) was used to adjust the pressure profile in the extruder (pressure-rotation-rate control) in a manner such that the blowing agent was completely mixed into the polymer melt. The melt pump serves not only to adjust the pressure profile by the twin-screw extruder but also to convey the blowing-agent-impregnated polymer melt through the downstream equipment (the start-up valve, the melt sieve and the pelletizing die). The melt extrudate emerging through the pelletizing die (1 hole with 1.0 mm diameter) was expanded under counter pressure in the underwater pelletizer (UWP) and chopped to give polyether sulfone pellets with a pellet weight in the range of 3-10 mg. The total throughput of the extruder was kept constant here at 4.6 kg/h. The extrudate in the water box was chopped by 6 blades attached to a blade ring. The blade ring here rotates at 3600 rpm. This gives porous pellets, which are transported by the water circuit from the pelletizing die into the drier, and from there are deposited into a collection vessel. Table 1 collates the proportions by weight of the raw materials used. The proportion of water is based on the quantity added per 100 proportions by weight of polymer. Table 2 collates the process parameters.

Comparative Experiments:

Comparative experiment V1 was carried out in the same way as examples B-1 to B-6, with the process parameters stated in Table 1.

TABLE 1
Process parameters

| | | | | | | | | | Water | Water | |
|---|---|---|---|---|---|---|---|---|---|---|---|
| Experi- | Through- | | | | | | | Extruder | temp. | pressure | Pellet |
| ment | put | Ultrason 2010 | | Ultrason 3010 | | Water | | temp | UWP | UWP | mass |
| No. | g/h | Proportions | g/h | Proportions | g/h | Proportions | g/h | (° C.) | (° C.) | [bar] | mg |
| B-1 | 4603 | 100 | 4500.39 | | | 2.28 | 102.61 | 340 | 90 | 5 | 3.3 |
| B-2 | 4603 | | | 100 | 4500.39 | 2.28 | 102.61 | 340 | 90 | 5 | 5.7 |
| B-3 | 4603 | | | 100 | 4500.39 | 2.28 | 102.61 | 340 | 90 | 2.5 | 6.3 |
| B-4 | 4603 | | | 100 | 4468.93 | 3.00 | 134.07 | 340 | 90 | 5 | 6.4 |
| B-5 | 4603 | | | 100 | 4468.93 | 3.00 | 134.07 | 340 | 90 | 3 | 6.0 |
| B-6 | 4603 | | | 100 | 4425.96 | 4.00 | 177.04 | 340 | 90 | 3 | 8.3 |
| V-1 | 4603 | | | 100 | 4383.81 | 5.00 | 219.19 | 340 | 90 | 3 | 9.3 |

TABLE 2
Properties

| | | Dry bulk | | | | Flow- | |
|---|---|---|---|---|---|---|---|
| Exper- | | density | Particle | Solubility | | ability | |
| iment | | trocken | mass | in NMP | VOC | value | |
| No. | Product | g/l | mg | [min] | [%] | [sec] | L/D |
| B-l | Ultrason E | 296 | 3.3 | 47 | <0.01 | | 1.1 |
| | 2010 | | | | | | |
| B-2 | Ultrason E | 289 | 5.7 | 24 | <0.01 | 3.07 | 1.2 |
| | 3010 | | | | | | |
| B-3 | Ultrason E | 271 | 6.3 | 29 | <0.01 | 4.07 | 1.2 |
| | 3010 | | | | | | |
| B-4 | Ultrason E | 269 | 6.4 | 16 | <0.01 | 3.17 | 1.5 |
| | 3010 | | | | | | |
| B-5 | Ultrason E | 271 | 6.0 | 29.0 | <0.01 | 3.2 | 1.6 |
| | 3010 | | | | | | |
| B-6 | Ultrason E | 182 | 8.3 | 29 | <0.01 | 4.13 | 1.8 |
| | 3010 | | | | | | |
| V-1 | Ultrason E | 92 | 9.3 | 13 | <0.01 | not | 2.7 |
| | 3010 | | | | | flowable | |

1. A granulate based on high-temperature thermoplastics, selected from the group of polyaryl ether sulfones, polyaryl ether ketones, polyphenylene sulfides, polyetherimides, polyphenyleneamides, polycarbonates, aromatic polyester carbonates, high-temperature polyamides (HTPA), thermoplastic polyoxazolidones and copolycarbonates or mixtures thereof, with a bulk density in the range of 100 to 650 kg/m³ in accordance with DIN ISO 697:1984 and less than 1% by weight content of volatile organic compounds.

2. The granulate according to claim 1, wherein said granulate has less than 0.01% content of volatile organic compounds.

3. The granulate according to claim 1, wherein the mass per pellet of said granulate is in the range of 3 to 8.5 mg.

4. The granulate according to claim 1, wherein the L/D ratio of said granulate is in the range of 1/1 to 2.5/1.

5. The granulate according to claim 1, wherein 2 g of the granulate dissolve in 100 ml of N-methylpyrrolidone at 80° C. in less than 60 minutes.

6. The granulate according to claim 1, wherein the flowability value of said granulate is in the range of 1 to 6 seconds, measured in accordance with DIN EN ISO 6186:1998.

7. The granulate according to claim 1, wherein said granulate consists of a high-temperature thermoplastic with an intrinsic viscosity in the range of 40 to 100 cm³/g, measured in accordance with DIN EN ISO 1628-1:2012-10 in 0.01 g/ml phenol/1.2 ortho-dichlorobenzene, 1:1.

8. The granulate according to claim 1, wherein said granulate consists of a polyaryl ether sulfone as high-temperature thermoplastic.

9. A method for the production of granulates based on high-temperature thermoplastics according to claim 1, comprising the stages of:
a) production of a polymer melt via melting of at least one high-temperature thermoplastic with less than 1% by weight content of volatile organic compounds,
b) addition of a blowing agent to the polymer melt
c) conveying of the polymer melt by way of a gear pump
d) conveying of the blowing-agent-containing polymer melt at a temperature in the range of 250° C. to 350° C. through a pelletizing die and
e) granulation of the blowing-agent-loaded polymer melt.

10. A method for the production of granulates based on polyaryl ether sulfones according to claim 8, comprising the stages of:
a) production of a polymer melt via reaction of a dichlorodiphenyl sulfone component with a bisphenol component as monomers in the presence of alkali metal carbonate in the melt in the absence of solvents or diluents, followed by removal of salts,
b) addition of a blowing agent to the polymer melt
c) conveying of the polymer melt by way of a gear pump
d) conveying of the blowing-agent-containing polymer melt at a temperature in the range of 250° C. to 350° C. through a pelletizing die and
e) granulation of the blowing-agent-loaded polymer melt.

11. The method according to claim 9, wherein the granulation in stage e) takes place in an underwater pelletizer operated at a water temperature in the range of 75 to 99° C. and at a pressure in the range of 1 to 10 bar.

12. The method according to claim 9, wherein nitrogen, carbon dioxide, water or mixtures thereof are used as blowing agent.

13. The method according to claim 9, wherein a polyarylene ether sulfone with an intrinsic viscosity in the range of 40 to 100 cm³/g, measured in accordance with DIN EN ISO 1628-1:2012-10 in 0.01 g/ml phenol/1,2 ortho-dichlorobenzene, 1:1 is used as high-temperature thermoplastic.

14. The use of the granulates according to claim 1 for the production of membranes or coatings, or for the toughness-modification of reactive resins.

15. A method for the production of granulates based on high-temperature thermoplastics according to claim 1, comprising the stages of:
a) production of a polymer melt via melting of at least one high-temperature thermoplastic with less than 1% by weight content of volatile organic compounds,
b) addition of a blowing agent to the polymer melt
c) conveying of the blowing-agent-containing polymer melt at a temperature in the range of 250° C. to 350° C. through a pelletizing die and
d) granulation of the blowing-agent-loaded polymer melt.

16. A method for the production of granulates based on polyaryl ether sulfones according to claim 8, comprising the stages of:
a) production of a polymer melt via reaction of a dichlorodiphenyl sulfone component with a bisphenol component as monomers in the presence of alkali metal carbonate in the melt in the absence of solvents or diluents, followed by removal of salts,
b) addition of a blowing agent to the polymer melt
c) conveying of the blowing-agent-containing polymer melt at a temperature in the range of 250° C. to 350° C. through a pelletizing die and
d) granulation of the blowing-agent-loaded polymer melt.

17. The method according to claim 15, wherein the granulation in stage d) takes place in an underwater pelletizer operated at a water temperature in the range of 75 to 99° C. and at a pressure in the range of 1 to 10 bar.

18. The method according to claim 15, wherein nitrogen, carbon dioxide, water or mixtures thereof are used as blowing agent.

19. The method according to claim 15, wherein a polyarylene ether sulfone with an intrinsic viscosity in the range of 40 to 100 cm³/g, measured in accordance with DIN EN ISO 1628-1:2012-10 in 0.01 g/ml phenol/1,2 ortho-dichlorobenzene, 1:1 is used as high-temperature thermoplastic.
